(19) United States
(12) Patent Application Publication
(10) Pub. No.: US 2016/0182603 A1
(43) Pub. Date: Jun. 23, 2016

(54) Browser Display Casting Techniques

(71) Applicant: Microsoft Technology Licensing, LLC, Redmond, WA (US)

(72) Inventors: Yongik Chung, Redmond, WA (US); Elizabeth F. Threlkeld, Redmond, WA (US); Paula J. Chuchro, Seattle, WA (US); John Wesley Terrell, Kirkland, WA (US)

(21) Appl. No.: 14/576,790

(22) Filed: Dec. 19, 2014

(51) Int. Cl. H04L 29/08; G06F 3/0484

(52) U.S. Cl. CPC H04L 67/025; G06F 3/04847; H04L 67/02

(57) ABSTRACT

Browser display casting techniques are described. In one or more implementations, content is displayed within a browser on a display device of a mobile communications device, the mobile communications device having a form factor configured to be held by one or more hands of a user. An input is received to cast the display of the browser to another display device that is communicatively coupled to the mobile communications device, the other display device having an available display area that is greater than an available area of the display device of the mobile communications device. Responsive to the input, the content within the web browser on the other computing device is caused to be displayed by communicating the content to the other display device by the mobile communications device without reloading the content, the browser displayed on the other display device as having one or more visual graphical interface features of chrome of the browser that are not displayed on the display device of the mobile communications device.

### BACKGROUND

Users have access to a devices having a variety of different form factors that are optimized for different uses. For example, a mobile communications device, such as a mobile phone or tablet, may include a housing that is configured to be held by one or more hands of a user. As the mobile communications device is configured to be mobile, however, an available display area of the display device may be limited to promote this mobility.

Limitations in this available display area have resulted in the coding of dedicated applications for these configurations. However, conventional techniques utilized to cast a display of these dedicated applications to other display devices are thus limited by this device-specific coding. Additionally, conventional techniques to perform this casting typically involve burdensome workarounds, which may be inefficient and frustrating to users in practice as well as consume additional device and network resources.

### SUMMARY

Browser display casting techniques are described. In one or more implementations, content is displayed within a browser on a display device of a mobile communications device, the mobile communications device having a form factor configured to be held by one or more hands of a user. An input is received to cast the display of the browser to another display device that is communicatively coupled to the mobile communications device, the other display device having an available display area that is greater than an available area of the display device of the mobile communications device. Responsive to the input, the content within the web browser on the other computing device is caused to be displayed by communicating the content to the other display device by the mobile communications device without reloading the content, the browser displayed on the other display device as having one or more visual graphical interface features of chrome of the browser that are not displayed on the display device of the mobile communications device.

In one or more implementations, content is displayed within a browser on a display device of a mobile communications device in a mobile mode, the mobile communications device having a form factor configured to be held by one or more hands of a user. Responsive to receipt of input to cast the display of the browser to another display device having an available display area that is greater than an available area of the display device of the mobile communications device, the display of the content within the web browser is caused to be displayed in a non-mobile mode on the other computing device by communicating the content to the other display device by the mobile communications device without reloading the content. The browser is displayed on the other display device as having one or more visual graphical interface features of chrome of the browser that are not displayed on the display device of the mobile communications device.

In one or more implementations, a mobile communications device includes a housing having a hand-held form factor that is configured to be held by one or more hands of a user, a display device secured to the housing and having an available display area, a processing system disposed within the housing, and memory disposed within the housing. The memory is configured to maintain a browser as one or more instructions that are executable by the processing system to perform operations including receiving an input to cast a display of content of a browser on the display device to another display device that is communicatively coupled to the mobile communications device, the other display device having an available display area that is greater than an available area of the display device of the mobile communications device. The operations also include causing the display of the content within the web browser on the other computing device by communicating the content to the other display device without reloading the content, the browser displayed on the other display device as having one or more visual graphical interface features of chrome of the browser that are not displayed on the display device of the mobile communications device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to perform browser display casting techniques.

FIG. 2 depicts a system in an example implementation showing a casting module of FIG. 1 as supporting a plurality of modes for display of a user interface of a browser.

FIG. 3 depicts a system in an example implementation showing a casting module of FIG. 1 as supporting a variety of user interactions through entry of inputs using the display device of mobile communications device and/or the other display device.

FIGS. 4-6 depict examples of configuration of a user interface cast by the mobile communications device for display by the other display device that supports multitasking.

FIG. 7 is a flow diagram depicting a procedure in an example implementation in which a plurality of display modes of a browser are employed to display content.

FIG. 8 is a flow diagram depicting a procedure in an example implementation in which a display of a browser is cast to another display device by a mobile communications device.

FIG. 9 illustrates an example system including various components of an example device that can be implemented as any type of computing device as described with reference to FIGS. 1-8 to implement embodiments of the techniques described herein.

### DETAILED DESCRIPTION

### Overview

Users today undergo burdensome workarounds in conventional techniques to show web content from one device on another, especially when going from a mobile communications device to larger display devices. For example, users may email themselves a URL and then proceed to a larger device, log in to their email account on that device's browser and launch the link from there, and so on. Additionally, although there are solutions that allow users to project a screen from one device to another, these techniques typically cast just the content, e.g., a webpage being viewed. Thus, this does not allow the user to continue to use the browser through interaction on that larger screen and consequently limits that interaction to a primary screen of the device that initiated the casting.

Browser display casting techniques are described. In one or more implementations, a browser is configured to support a plurality of modes to support webpage navigation. The browser, for instance, may be configured to support a mobile mode for use in conjunction with a mobile communications device, such as a mobile phone, tablet, and so on having a display device size of eight inches diagonal or less.

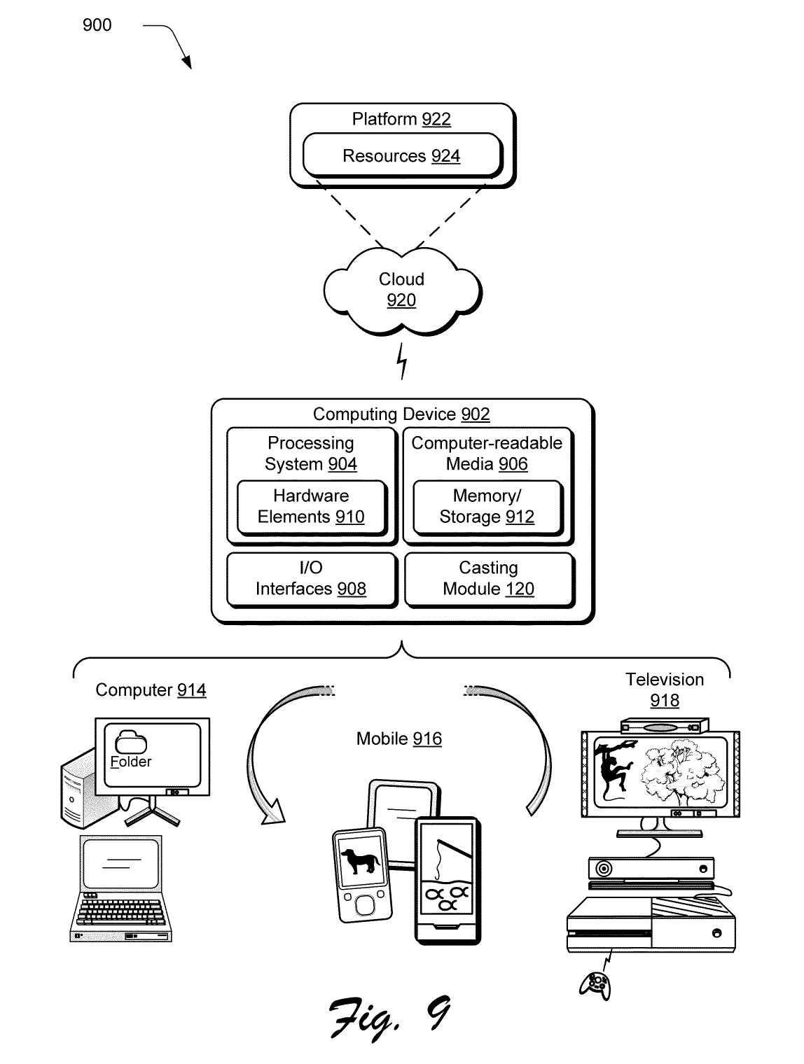

The browser may also be configured to support a non-mobile mode that is configured for relatively large format display devices, such as in a desktop or television configuration as further described in relation to FIG. 9. The non-mobile mode, for instance, may be configured to make use of additional display area of another display device that is communicatively coupled to the mobile communications device. This may include use of one or more visual graphical interface features of chrome of the browser on the other display device that are not displayed on the display device of the mobile communications device. Further, this may be performed without reloading a webpage displayed by the mobile communications device, thereby conserving network and processing resources and yet improving efficiency in an output of the webpage by the other display device.

For example, a user may interact with a webpage displayed via a browser of a mobile communications device. The user may then provide inputs to cause the browser to be displayed on another display device, such as a television, monitor, through use of a game console, and so on. The browser, upon receiving these inputs, may then cast the UI of the browser to the other display device. The UI may include the webpage without reloading the webpage. The browser, for instance, may receive the input as a resize event via an application programming interface and causes drawing of the one or more visual graphical interface features of the chrome of the browser to fit an available display area of the other display device. Further, the UI as displayed on the other display device may include visual graphical interface features of chrome of the browser that are not displayed by the mobile communications device, such as tabs, menus items, toolbars, taskbars, and so forth.

Additionally, techniques may be employed to support interaction via the mobile communications device and/or the other display device. A user, for instance, may provide inputs via interaction with the other display device which may cause operations to be performed by the mobile communications device. In another example, the mobile communications device may be re-configured upon casting such that the mobile communications device acts as an input device, such as a game controller, keyboard, and so forth.

Techniques may be employed to support a simultaneous display of multiple applications and even instances of the browser itself on the other display device. In this way, the power of the browser may be realized on a large screen and leverage the mobile communications device to perform the processing and may go beyond conventional techniques that are limited solely to casting the webpage, alone, to the other display device. Further discussion of these and other examples may be found in relation to the following sections. Although a browser is described in the following, casting functionality described herein may be implemented in a variety of other ways, such as via other applications, operating systems, a plug-in module, and so on.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

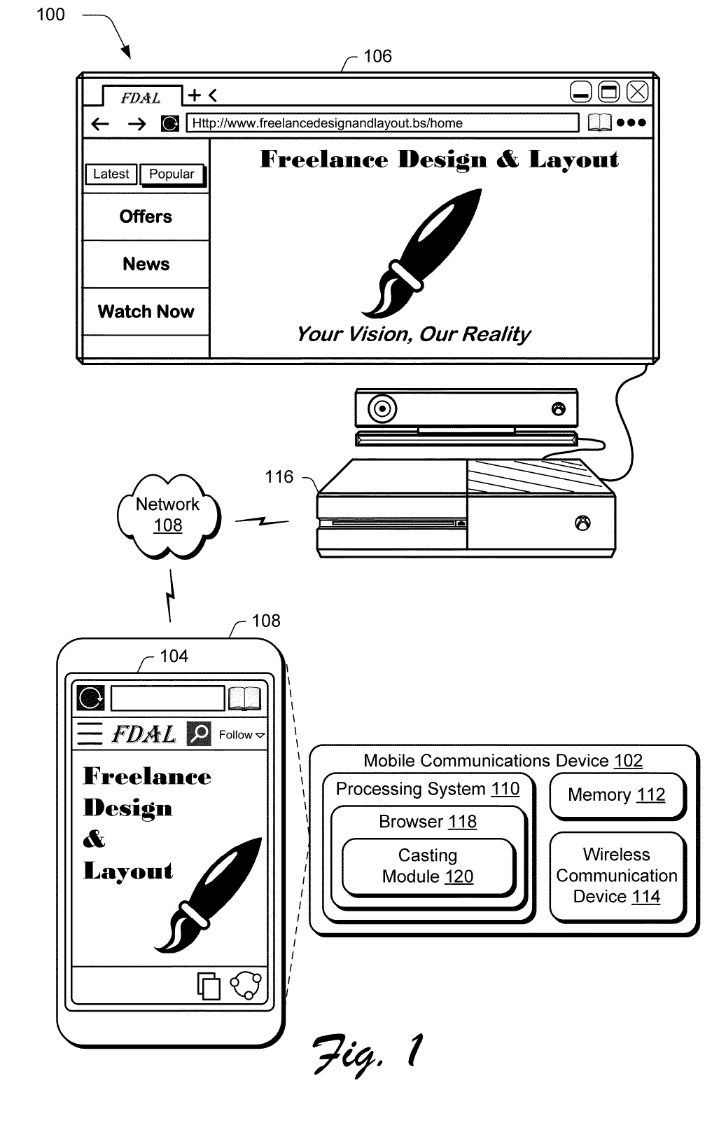

FIG. 1 is an illustration of an environment 100 in an example implementation that is operable to employ the browser casting techniques described herein. The illustrated environment 100 includes a mobile communications device 102 having a display device 104 and another display device 106 that are communicatively coupled, one to another, via a network 108.

The mobile communications device 102 may be configured in a variety of ways. For example, the mobile communications device 102 may be configured as a mobile station, an entertainment appliance, a portable game device, may have a housing 108 configured in accordance with a handheld configuration (e.g., a mobile phone or tablet in a slate or clamshell configuration) and thus configured to be held by one or more hands of a user, and so forth. Thus, the mobile communications device 102 may range from full resource devices with substantial memory and processor resources (e.g., tablet computers) to low-resource devices with limited memory and/or processing resources (e.g., hand-held game consoles).

The computing device 102 is illustrated as including a processing system 110, an example of a computer-readable storage medium illustrated as memory 112, the display device 104, and a wireless communication device 114. The processing system 110 is representative of functionality to perform operations through execution of instructions stored in the memory 112. Although illustrated separately, functionality of these components may be further divided, combined (e.g., on an application specific integrated circuit), and so forth.

The wireless communication device 114 may be configured in a variety of ways to support a variety of wireless communication techniques. For example, the wireless communication device 114 may communicate with the other display device 106 directly or indirectly (e.g., via a game console 116 as illustrated, a set-top box, and so on) via the network 108 using a Wi-Fi connection (e.g., one or more standards in accordance with IEEE 802.11), a Bluetooth® connection, near field communication (NFC), and so forth. Wide area network configurations are also contemplated, such as the Internet.

The mobile communications device 102 is further illustrated as including a browser 118. The browser 118 is representative of functionality of the mobile communications device 102 to retrieve, present, and traverse content resources on the Internet, e.g., World Wide Web. The browser 118, for instance, may be configured to access content via a Uniform Resource Locator (URL) to load content such as webpages, images, videos, and so forth.

The browser 118 in the illustrated example is shown as including a casting module 120. The casting module 120 is representative of functionality to cast a display of a user interface of the browser 118 to another display device 106 for display by that other display device 106, either directly or indirectly as described above. For example, the casting module 120 may be configured to cast this display to the other computing device 106 without reloading the content, e.g., a webpage, and may thus conserve resources of the mobile communications device 102, other computing device 106, and even network resources 108. Additionally, this casting may be performed in a manner to make additional functionality of the browser 118 readily available to a user, thereby increasing efficiency of user interaction, further discussion of which may be found in the following and is shown in a corresponding figure.

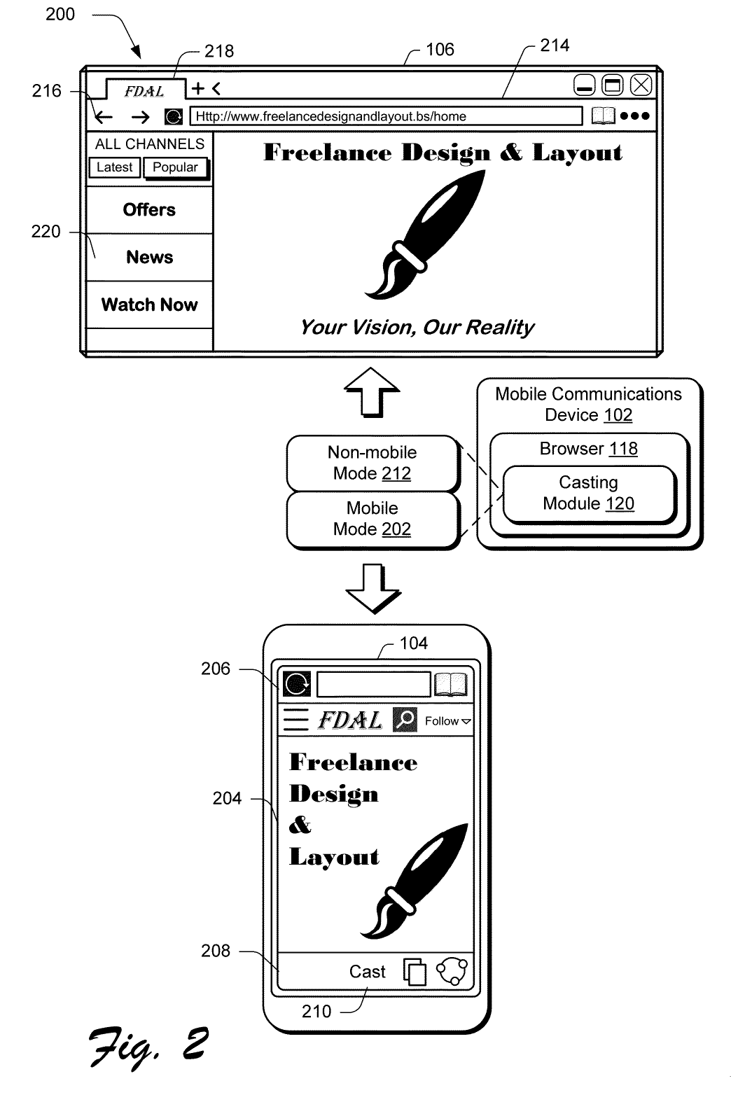

FIG. 2 depicts a system 200 in an example implementation showing a casting module 120 of FIG. 1 as supporting a plurality of modes for display of a user interface of the browser 118. The system 200 includes the mobile communications 102 and the other display device 106 as previously described. A user may utilize the casting module 120 to cause display of a user interface of the browser 118 to be cast from the mobile communications device 102 to the other display device 106.

For example, a user may interact with the display device 104 of the mobile communications device 102 (e.g., via touchscreen functionality, a gesture, and so forth) in a mobile mode 202 to navigate to content that is displayed within a user interface 204 of the browser 118 on the mobile communications device 102, which in this instance is a webpage. As the user interface 204 in this example corresponds to a mobile mode 202, the user interface 204 is configured to include a limited amount of display of chrome of the user interface. For example, chrome of the user interface includes visual graphical interface features, instances of which include a search bar 206 having a reload option, a bookmark option, and an input option and a taskbar 208 having a copy and share option. The chrome of the user interface in the mobile mode 202 may be configured to be hidden until output through prompting by a user, e.g., a swipe from an edge of the display device 104, to cause output of the chrome. In this way, valuable display area of the display device 104 may be conserved.

A user may then select an option 210 to cause an input to cast a display of a user interface of the browser 118 to the other display device 106. Responsive to receipt of the input, the casting module 120 casts the display by first detecting display capabilities of the other display device 106, such as resolution, refresh rate, available display area, and so on, e.g., via a wireless or wired network connection. Responsive to detection that a relatively large amount of display area is available, e.g., more than 8 inches diagonal, the casting module 120 employs a non-mobile (e.g., desktop or television) mode 212 to display a user interface of the browser 118.

In the non-mobile mode 212, an available display area of the content (e.g., the webpage in this example) is increased in comparison with the user interface displayed by the display device 104 of the mobile communications device 102. Thus, additional display elements of the content may be viewed that are not currently available on the display device 104 of the mobile communications device 102 without scrolling.

The non-mobile mode 212 of the casting module 120 also configures chrome of the browser 118 to leverage an increase in available display area of the other display device 106. For example, the chrome may also include a search bar 214 having a reload option, a bookmark option, an input option like the user interface displayed on the display device 104 of the mobile communications device 102. The search bar 214 in this case also includes a forward and back options 216 for navigation, and also supports tabs 218 that are selectable to navigate between content, e.g., webpages that have been downloaded and thus are locally available.

An additional example of visual graphical interface features includes a sidebar 220 that includes options to navigate between content channels of a website. Other visual graphical interface features are also contemplated, such as taskbars, notifications, and so on. In this way, additional functionality of the browser 118 may be made available to the user through interaction with the other display device 106 that is not otherwise available. Inputs may also be communicated between the mobile communications device 102 and the other display device 106 to support interaction between the user interfaces, further discussion of which may be found in in the following and is shown in a corresponding figure.

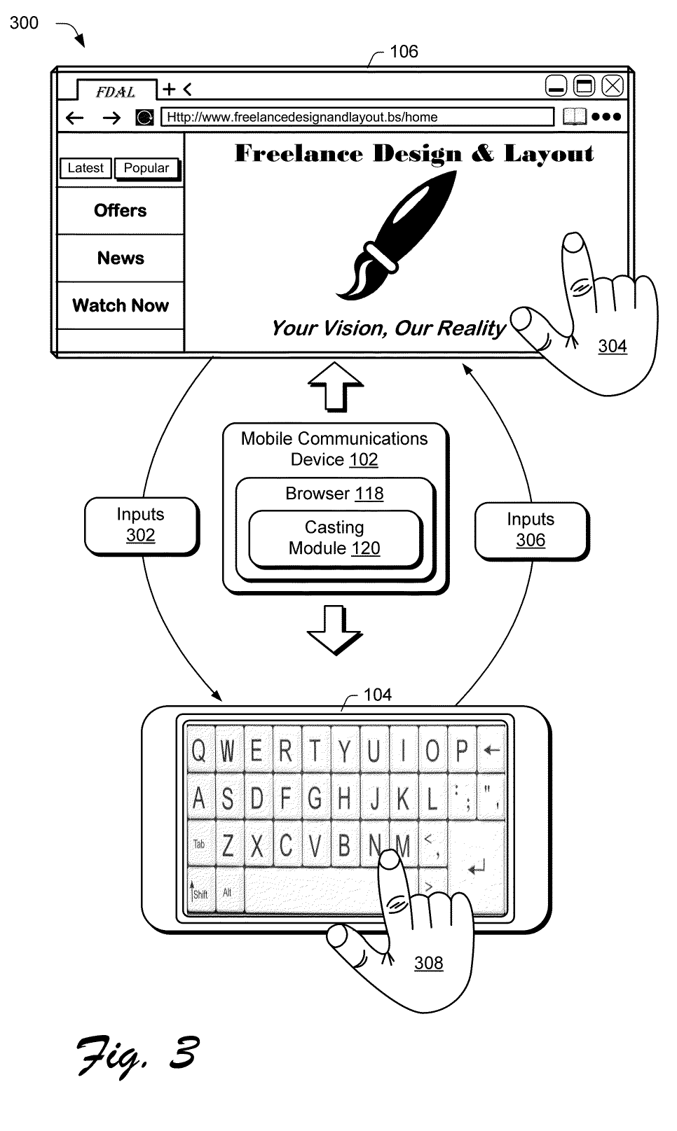

FIG. 3 depicts a system 300 in an example implementation showing the casting module 120 of FIG. 1 as supporting a variety of user interactions through entry of inputs using the display device 104 of the mobile communications device and/or the other display device 106. Inputs may be entered in a variety of ways. For example, a user may interact with the other display device 106, once cast, to generate inputs 302 that are communicated back to the mobile communications device 102 to implement one or more operations, such as to navigate to different items of content, interact with the display of the content, and so on. The inputs are detectable in a variety of ways, such as through touchscreen functionality of the other display device 106 (e.g., detecting proximity of one or more fingers of a user's hand 304), captured by a camera (e.g., gestures made as part of a natural user interface), voice commands, and so forth.

Inputs may also be received via interaction with the display device 104 of the mobile communications device 102, which are then be used to control output of a user interface displayed by the other display device 106. For example, a gesture is detected which causes navigation within a display of content, navigation to another item of content, and so on. Additionally, in one or more implementations the display device 104 of the mobile communications device 102 is configured automatically and without user intervention as part of the casting to act as a dedicated input device in that a display of the content is not included on the display device 104 of the mobile communications device 102. In the illustrated example, the user interface is configured as a keyboard that is selectable by one or more fingers of a user's hand 308 to initiate inputs. These inputs, for instance, may be used to enter a search query, complete a form, and so forth. Other configurations are also contemplated, such as a game pad, gesture input device, television controller, and so forth. In this way, a user gains increased efficiency through interaction with an expanded input functionality of the display device 104 of the mobile communications device 102 and still gains increased viewing functionality of content and chrome from the other display device 106. Additional examples that leverage a concurrent display on the other display device 106 provided by the mobile communications device 102 is found in the following and shown in a corresponding figure.

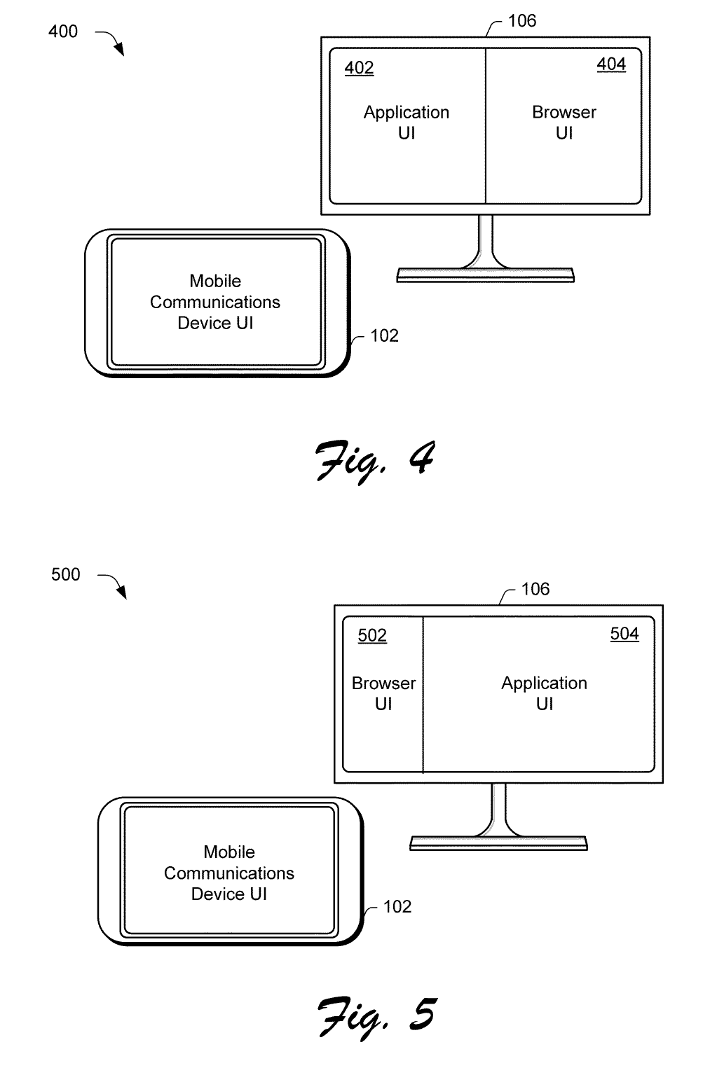

FIGS. 4-6 depict examples 400, 500, 600 of configuration of a user interface cast by the mobile communications device 102 for display by the other display device 106 that supports multitasking. As shown in the example 400 of FIG. 4, a user interacts with an application user interface 402 via the mobile communications device 102 and/or other display device 106 as previously described. The user, for instance, selects a link in a social network service. Responsive to this selection, a browser user interface 404 is launched and displayed concurrently with the application user interface 402 and thus leverages the browsers 118 ability to handle “http://” requests.

In the example 500 of FIG. 5, a browser user interface 502 it output initially and causes launching of another application. An application user interface 504 is then output simultaneously with the browser UI 502. For instance, a user may select a “mailto:” link that causes launch of a mail application, which responds by resizing of the browser UI 502 and display of the application user interface 504. As illustrated, an amount of available display area consumed by the respective browser and application user interfaces 502, 504 may be different, one to another.

In the example 600 of FIG. 6, multiple browser user interface 602, 604 are displayed concurrently, such as to leverage webpages or other content available via different tabs in a side-by-side manner. Additionally, a user may resize these views using a sizing portion 606 that is usable to resize both browser user interfaces 602, 604 simultaneously. Thus, the mobile communications device 102 may employ a browser 118 that leverages another display device 106 in a manner that takes advantage of an increased display area of the other display device 106 or even additional display area, e.g., the other display device 106 has a same size or is smaller than a display device 104 of the mobile communications device 102. Further discussion of these techniques may be found in relation to the following procedures.

Example Procedures

The following discussion describes browser display casting techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-6 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

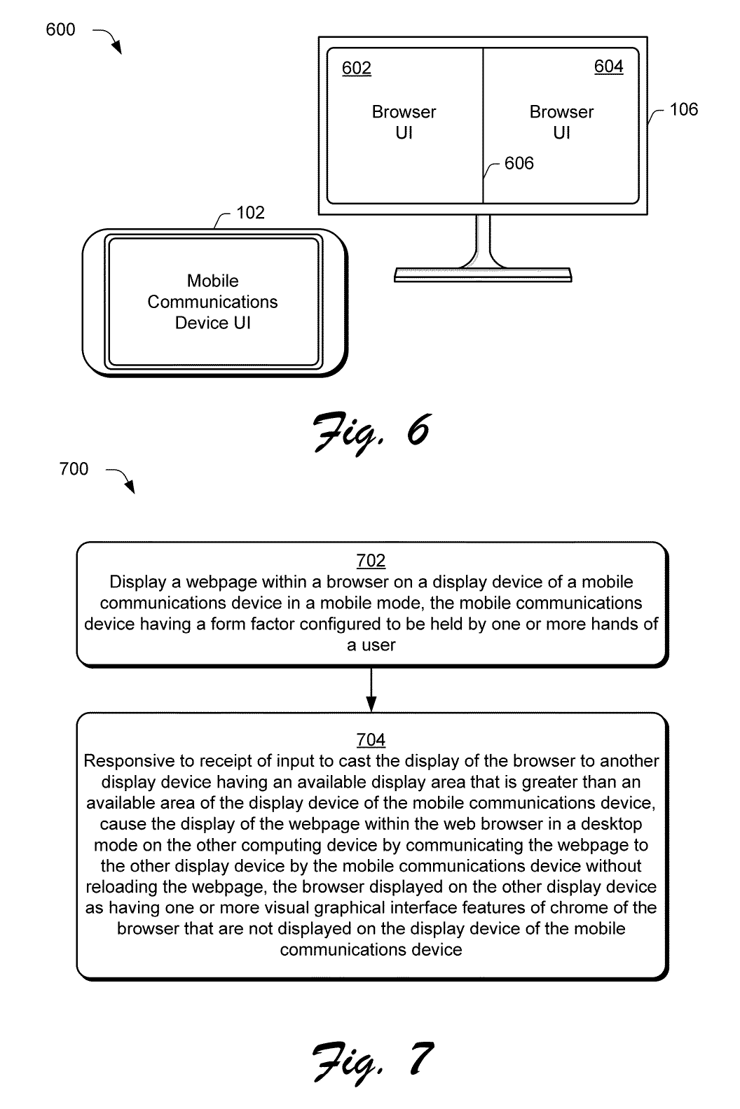

FIG. 7 depicts a procedure 700 in an example implementation in which a plurality of display modes of a browser are employed to display content. Content is displayed within a browser on a display device of a mobile communications device in a mobile mode, the mobile communications device having a form factor configured to be held by one or more hands of a user (block 702). As shown in FIG. 2, for instance, a display device 104 of a mobile communications device 102 displays content configured as a webpage. The mobile communications device 102 has a housing that is configured to be held and supported by one or more hands of a user, e.g., a slate, clamshell configuration, and so on for a mobile phone or tablet.

Responsive to receipt of input to cast the display of the browser to another display device having an available display area that is greater than an available area of the display device of the mobile communications device, the display of the content within the web browser is caused to be displayed in a non-mobile mode on the other computing device by communicating the content to the other display device by the mobile communications device without reloading the content. The browser is displayed on the other display device as having one or more visual graphical interface features of chrome of the browser that are not displayed on the display device of the mobile communications device (block 704). The casting module 120, for instance, may receive inputs involving selection of an option 210 to cast a display of the browser 118 to another display device 106. In response, the casting module 120 assumes control of the other display device 106 and causes display of a user interface of the browser 118. The user interface is configured to include one or more visual graphical interface features of chrome that are not displayed by the display device 104 in the mobile mode 202, e.g., a tab 218 or other element as illustrated.

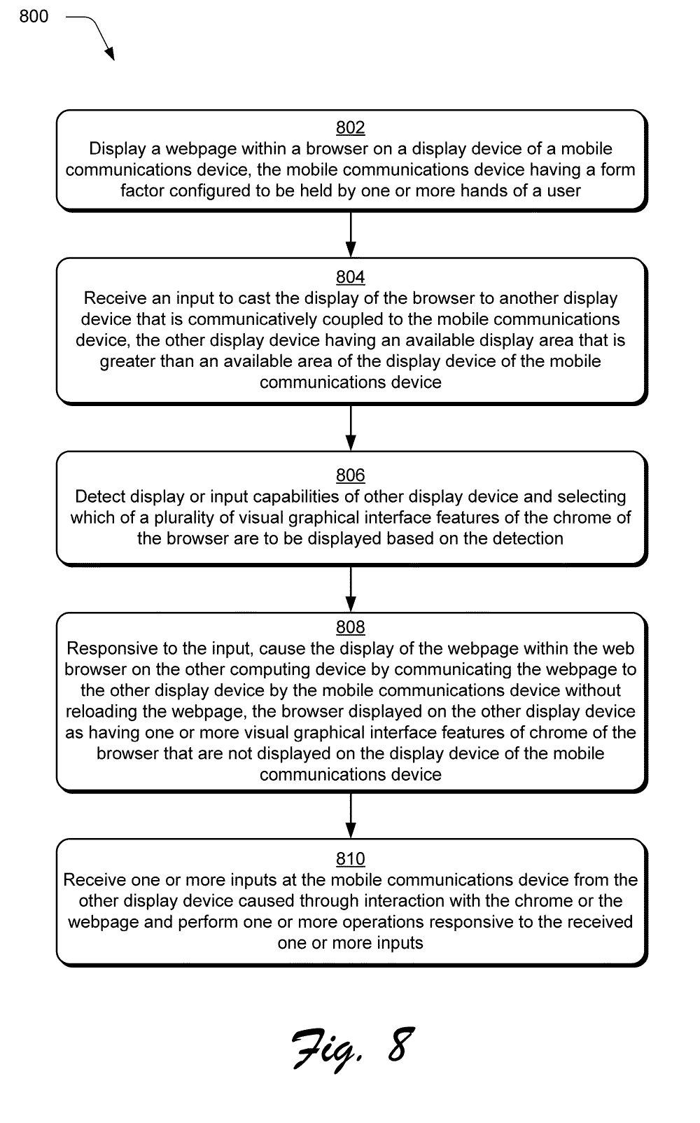

FIG. 8 depicts a procedure 800 in an example implementation in which a display of a browser is cast to another display device by a mobile communications device. Content is displayed within a browser on a display device of a mobile communications device, the mobile communications device having a form factor configured to be held by one or more hands of a user (block 802). As before, a variety of content may be displayed by the browser on the display device 104 that is secured to a housing of the mobile communications device 102.

An input is received to cast the display of the browser to another display device that is communicatively coupled to the mobile communications device, the other display device having an available display area that is greater than an available area of the display device of the mobile communications device (block 804). Continuing the previous example, the other display device 106 is configured as a television having a display area that is greater than a display area available via the display device 104.

Display or input capabilities of the other display device are detected and a selection is made as to which of a plurality of graphical interface features of chrome of the browser are to be displayed is made based on the detection (block 806). The casting module 120, for instance, may be configured to detect display capabilities of the other display device 106, such as resolution, aspect ratios, and other features and configure a user interface of the browser 118 accordingly. In another instance, input capabilities may also be detected and used to configure the user interface, such as whether the other display device 106 includes touchscreen functionality, includes a camera configured to capture and recognize gestures, and so on. These capabilities are then used as a basis to configure the user interface to recognize the inputs.

Responsive to the input, the content within the web browser on the other computing device is caused to be displayed by communicating the content to the other display device by the mobile communications device without reloading the content, the browser displayed on the other display device as having one or more visual graphical interface features of chrome of the browser that are not displayed on the display device of the mobile communications device (block 808). The casting module 120 of the browser 118, for instance, receives the input as a resize event via an application programming interface and causes drawing of the one or more visual graphical interface features of the content and/or chrome of the browser to fit an available display area of the other display device.

One or more inputs are received at the mobile communications device from the other display device that are caused through interaction with the chrome or the content and one or more operations are performed by the mobile communications device responsive to the received one or more inputs (block 810). Continuing with the previous input example, a user may select one or more visual graphical interface features or the content (e.g., webpage) itself and cause inputs to be communicated from the other display device 106 to the mobile communications device 102 to cause performance of one or more operations. A variety of other examples are also contemplated as previously described.

Example System and Device

FIG. 9 illustrates an example system generally at 900 that includes an example computing device 902 that is representative of one or more computing systems and/or devices that may implement the various techniques described herein. An example of this is illustrated through inclusion of the casting module 120 which may be utilized to cast a display of an application from one class of computing device to another. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 900, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 902 may assume a variety of different configurations, such as for computer 914, mobile 916, and television 918 uses. Each of these configurations includes devices that may have generally different constructs and capabilities, and thus the computing device 902 may be configured according to one or more of the different device classes. For instance, the computing device 902 may be implemented as the computer 914 class of a device that includes a personal computer, desktop computer, a multi-screen computer, laptop computer, netbook, and so on.

The computing device 902 may also be implemented as the mobile 916 class of device that includes mobile devices, such as a mobile phone, portable music player, portable gaming device, a tablet computer, a multi-screen computer, and so on. The computing device 902 may also be implemented as the television 918 class of device that includes devices having or connected to generally larger screens in casual viewing environments. These devices include televisions, set-top boxes, gaming consoles, and so on.

The techniques described herein may be supported by these various configurations of the computing device 902 and are not limited to the specific examples of the techniques described herein. This functionality may also be implemented all or in part through use of a distributed system, such as over a “cloud” 920 via a platform 922 as described below.

The cloud 920 includes and/or is representative of a platform 922 for resources 924. The platform 922 abstracts underlying functionality of hardware (e.g., servers) and software resources of the cloud 920. The resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices. The platform 922 may also serve to abstract scaling of resources to provide a corresponding level of scale to encountered demand for the resources 924 that are implemented via the platform 922. Accordingly, in an interconnected device embodiment, implementation of functionality described herein may be distributed throughout the system 900. For example, the functionality may be implemented in part on the computing device 902 as well as via the platform 922 that abstracts the functionality of the cloud 920.

Conclusion and Example Implementations

Example implementations described herein include, but are not limited to, one or any combinations of one or more of the following examples:

In one or more examples, content is displayed within a browser on a display device of a mobile communications device, the mobile communications device having a form factor configured to be held by one or more hands of a user. An input is received to cast the display of the browser to another display device that is communicatively coupled to the mobile communications device, the other display device having an available display area that is greater than an available area of the display device of the mobile communications device. Responsive to the input, the content within the web browser on the other computing device is caused to be displayed by communicating the content to the other display device by the mobile communications device without reloading the content, the browser displayed on the other display device as having one or more visual graphical interface features of chrome of the browser that are not displayed on the display device of the mobile communications device.

An example as described alone or in combination with any of the other examples described above or below this example, in which the display of the web browser on the mobile communications device corresponds to a mobile mode and the display of the browser on the other display device corresponds to a non-mobile mode.

An example as described alone or in combination with any of the other examples described above or below this example, in which the visual graphical interface features of chrome of the browser include one or more tabs, menu items, notifications, menu bars, or taskbars.

An example as described alone or in combination with any of the other examples described above or below this example, in which the visual graphical interface features of chrome of the browser are caused to be displayed concurrently with the content.

A method as described in claim 1, further comprising receiving one or more inputs at the mobile communications device from the other display device caused through interaction with the chrome or the content and performing one or more operations responsive to the received one or more inputs.

An example as described alone or in combination with any of the other examples described above or below this example, in which detecting display capabilities of other display device, selecting which of a plurality of visual graphical interface features of the chrome of the browser are to be displayed based on the detection, and wherein the causing specifies the selected graphical interface features for display by the other display device.

An example as described alone or in combination with any of the other examples described above or below this example, further comprising detecting input capabilities of other display device, selecting which of a plurality of visual graphical interface features of the chrome of the browser are to be displayed based on the detection, and wherein the causing specifies the selected graphical interface features for display by the other display device.

An example as described alone or in combination with any of the other examples described above or below this example, in which the browser receives the input as a resize event via an application programming interface and causes drawing of the one or more visual graphical interface features of the chrome of the browser to fit an available display area of the other display device.

An example as described alone or in combination with any of the other examples described above or below this example, in which the causing further comprises configuring the display device of the mobile communications device to act as an input device through configuration as a game pad, keyboard, gesture input device, or television controller.

An example as described alone or in combination with any of the other examples described above or below this example, in which the causing further causes simultaneous output of the display of the content within the web browser on the other computing device along with at least one other user interface corresponding to other content or another application.

In one or more examples, content is displayed within a browser on a display device of a mobile communications device in a mobile mode, the mobile communications device having a form factor configured to be held by one or more hands of a user. Responsive to receipt of input to cast the display of the browser to another display device having an available display area that is greater than an available area of the display device of the mobile communications device, the display of the content within the web browser is caused to be displayed in a non-mobile mode on the other computing device by communicating the content to the other display device by the mobile communications device without reloading the content. The browser is displayed on the other display device as having one or more visual graphical interface features of chrome of the browser that are not displayed on the display device of the mobile communications device.

An example as described alone or in combination with any of the other examples described above or below this example, in which the causing further comprises configuring the display device of the mobile communications device to act as an input device.

An example as described alone or in combination with any of the other examples described above or below this example, in which the mobile communications device acts as the input device through configuration as a game pad, keyboard, gesture input device, or television controller.

An example as described alone or in combination with any of the other examples described above or below this example, in which the visual graphical interface features of chrome of the browser include one or more tabs, menu items, notifications, menu bars, or taskbars.

An example as described alone or in combination with any of the other examples described above or below this example, in which the visual graphical interface features of chrome of the browser are caused to be displayed concurrently with the content.

An example as described alone or in combination with any of the other examples described above or below this example, in which the browser receives the input as a resize event via an application programming interface and causes drawing of the one or more visual graphical interface features of the chrome of the browser to fit an available display area of the other display device.

In one or more examples, a mobile communications device includes a housing having a hand-held form factor that is configured to be held by one or more hands of a user, a display device secured to the housing and having an available display area, a processing system disposed within the housing, and memory disposed within the housing. The memory is configured to maintain a browser as one or more instructions that are executable by the processing system to perform operations including receiving an input to cast a display of content of a browser on the display device to another display device that is communicatively coupled to the mobile communications device, the other display device having an available display area that is greater than an available area of the display device of the mobile communications device. The operations also include causing the display of the content within the web browser on the other computing device by communicating the content to the other display device without reloading the content, the browser displayed on the other display device as having one or more visual graphical interface features of chrome of the browser that are not displayed on the display device of the mobile communications device.

An example as described alone or in combination with any of the other examples described above or below this example, in which the causing further comprises configuring the display device of the mobile communications device to act as an input device.

An example as described alone or in combination with any of the other examples described above or below this example, in which the mobile communications device acts as the input device through configuration as a game pad, keyboard, gesture input device, or television controller.

An example as described alone or in combination with any of the other examples described above or below this example, in which the visual graphical interface features of chrome of the browser include one or more tabs, menu items, notifications, menu bars, or taskbars.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
displaying content within a browser on a display device of a mobile communications device, the mobile communications device having a form factor configured to be held by one or more hands of a user;
receiving an input to cast the display of the browser to another display device that is communicatively coupled to the mobile communications device, the other display device having an available display area that is greater than an available area of the display device of the mobile communications device; and
responsive to the input, causing the display of the content within the web browser on the other computing device by communicating the content to the other display device by the mobile communications device without reloading the content, the browser displayed on the other display device as having one or more visual graphical interface features of chrome of the browser that are not displayed on the display device of the mobile communications device.

2. A method as described in claim 1, wherein the display of the browser on the mobile communications device corresponds to a mobile mode and the display of the browser on the other display device corresponds to a non-mobile mode.

3. A method as described in claim 1, wherein the visual graphical interface features of chrome of the browser include one or more tabs, menu items, notifications, menu bars, or taskbars.

4. A method as described in claim 1, wherein the visual graphical interface features of chrome of the browser are caused to be displayed concurrently with the content.

5. A method as described in claim 1, further comprising receiving one or more inputs at the mobile communications device from the other display device caused through interaction with the chrome or the content and performing one or more operations responsive to the received one or more inputs.

6. A method as described in claim 1, further comprising detecting display capabilities of other display device, selecting which of a plurality of visual graphical interface features of the chrome of the browser are to be displayed based on the detection, and wherein the causing specifies the selected graphical interface features for display by the other display device.

7. A method as described in claim 1, further comprising detecting input capabilities of other display device, selecting which of a plurality of visual graphical interface features of the chrome of the browser are to be displayed based on the detection, and wherein the causing specifies the selected graphical interface features for display by the other display device.

8. A method as described in claim 1, wherein the browser receives the input as a resize event via an application programming interface and causes drawing of the one or more visual graphical interface features of the chrome of the browser to fit an available display area of the other display device.

9. A method as described in claim 1, wherein the causing further comprises configuring the display device of the mobile communications device to act as an input device through configuration as a game pad, keyboard, gesture input device, or television controller.

10. A method as described in claim 1, wherein the causing further causes simultaneous output of the display of the content within the web browser on the other computing device along with at least one other user interface corresponding to other content or another application.

11. A method comprising:
displaying content within a browser on a display device of a mobile communications device in a mobile mode, the mobile communications device having a form factor configured to be held by one or more hands of a user; and
responsive to receipt of input to cast the display of the browser to another display device having an available display area that is greater than an available area of the display device of the mobile communications device, causing the display of the content within the web browser in a non-mobile mode on the other computing device by communicating the content to the other display device by the mobile communications device without reloading the content, the browser displayed on the other display device as having one or more visual graphical interface features of chrome of the browser that are not displayed on the display device of the mobile communications device.

12. A method as described in claim 11, wherein the causing further comprises configuring the display device of the mobile communications device to act as an input device.

13. A method as described in claim 12, wherein the mobile communications device acts as the input device through configuration as a game pad, keyboard, gesture input device, or television controller.

14. A method as described in claim 11, wherein the visual graphical interface features of chrome of the browser include one or more tabs, menu items, notifications, menu bars, or taskbars.

15. A method as described in claim 11, wherein the visual graphical interface features of chrome of the browser are caused to be displayed concurrently with the content.

16. A method as described in claim 11, wherein the browser receives the input as a resize event via an application programming interface and causes drawing of the one or more visual graphical interface features of the chrome of the browser to fit an available display area of the other display device.

17. A mobile communications device comprising:
a housing having a hand-held form factor that is configured to be held by one or more hands of a user;
a display device secured to the housing and having an available display area;
a processing system disposed within the housing; and
memory disposed within the housing and configured to maintain a browser as one or more instructions that are executable by the processing system to perform operations including:
receiving an input to cast a display of content of a browser on the display device to another display device that is communicatively coupled to the mobile communications device, the other display device having an available display area that is greater than an available area of the display device of the mobile communications device; and
causing the display of the content within the web browser on the other computing device by communicating the content to the other display device without reloading the content, the browser displayed on the other display device as having one or more visual graphical interface features of chrome of the browser that are not displayed on the display device of the mobile communications device.

18. A mobile communications device as described in claim 17, wherein the causing further comprises configuring the display device of the mobile communications device to act as an input device.

19. A mobile communications device as described in claim 18, wherein the mobile communications device acts as the input device through configuration as a game pad, keyboard, gesture input device, or television controller.

20. A mobile communications device as described in claim 17, wherein the visual graphical interface features of chrome of the browser include one or more tabs, menu items, notifications, menu bars, or taskbars.
